(19) United States
(12) Patent Application Publication
(10) Pub. No.: US 2020/0187514 A1
(43) Pub. Date: Jun. 18, 2020

(54) METHOD FOR PRESERVING CRUSTACEANS AND SEA FOODS

(71) Applicants: Hisaharu OKI, Sagamihara-shi (JP); Yukio MURATA, Saitama-shi (JP)

(72) Inventors: Hisaharu OKI, Sagamihara-shi (JP); Yukio MURATA, Saitama-shi (JP)

(21) Appl. No.: 16/217,767

(22) Filed: Dec. 12, 2018

(51) Int. Cl. A23B 4/24; A23B 4/09

(52) U.S. Cl. CPC A23B 4/24; A23V 2002/00; A23B 4/09

(57) ABSTRACT

The present invention has for its object to provide a simple technology capable of preserving sea foods, crustaceans or the like without decomposition over an extended period of time. As shown in FIG. 3, a sheet carrying calcium oxide powders and/or calcium hydroxide powders is laid down on the bottom of an enclosure while crustaceans or sea foods are placed on the top surface of the sheet, and water is then filled up within the enclosure. It is preferable that after the water is filled up within the enclosure, the sheet and the sea foods/crustaceans, etc. are frozen by rapid cooling to create an ice body including them for storage.

### ART FIELD

The present invention relates generally to a method for preserving crustaceans and sea foods, and more particularly to a method for preserving crustaceans and sea foods for the purpose of preserving sea food such as a live shrimp while it is prevented from suffering from diseases, and a preservation sheet used with that method.

### BACKGROUND ART

For instance, when live shrimps are transported to consumption areas, they are generally embedded or buried up in sawdust filled in a container.

For keeping shrimps alive, there is a method known in which live shrimps are slowly cooled to a low temperature at which they go into hibernation thereby keeping them at the low temperature (see Patent Publications 1 and 2).

### PRIOR ARTS

### Patent Publications

Patent Publication 1: JP(A) 5-49369
Patent Publication 2: JP(B) 7-8192

### SUMMARY OF THE INVENTION

### Prior Art Problems

As live shrimps are buried up in sawdust for delivery to consumers, however, it gives rise to a problem that they get rotten by proliferating bacteria, only to be thrown away.

There is also the need for filling much sawdust in a packing container, resulting in some problems: increases in the size of the packing container, and the scattering of sawdust from within the container at the time when a consumer takes the live shrimps out of the container, leading to troublesome cleaning.

An object of the invention is to provide a method for preserving sea foods and crustaceans safely and freshly thereby preserving them against decomposition due to proliferating bacteria.

### Embodiments of the Invention

Thus, the present invention provides a method for preserving crustaceans and sea foods as embodied below.
[1] A method for preserving crustaceans or sea foods, characterized in that a sheet carrying calcium oxide powders and/or calcium hydroxide powders is laid down on a bottom of an enclosure while the crustaceans or sea foods are placed on a top surface thereof, and water is then filled up within the enclosure.
[2] A method for preserving crustaceans or sea foods, characterized in that a woven or unwoven sheet carrying calcium oxide powders and/or calcium hydroxide powders is laid down on a bottom of an enclosure while a number of crustaceans or sea foods are arranged and placed in a row on a top surface thereof, and water is then filled up within the enclosure.
[3] A method for preserving crustaceans or sea foods, characterized in that a woven or unwoven sheet carrying calcium oxide powders or calcium hydroxide powders is laid down on a bottom of an enclosure while a number of crustaceans or sea foods are arranged and placed in a row on a top surface thereof, and water is then filled up within the enclosure and frozen.
[4] A method for preserving crustaceans or sea foods, characterized in that a woven or unwove sheet carrying calcium oxide powders and calcium hydroxide powders is laid down on a bottom of an enclosure while a number of crustaceans or sea foods are arranged and placed in a row on a top surface thereof, and water is then filled up within the enclosure and frozen.
[5] A method for preserving crustaceans or sea foods according to any one of [1] to [4], characterized in that the water filled up within the enclosure is an aqueous solution of calcium hydroxide.
[6] A method for preserving crustaceans or sea foods according to any one of [1] to [5], characterized in that the crustacean is a live shrimp that has been cooled and put into hibernation.
[7] A method for preserving crustaceans or sea foods according to [6], characterized in that the live shrimp has a head.
[8] A sheet for use with the method for preserving crustaceans or sea foods according to any one of [1] to [7], characterized in that calcium oxide powders or calcium hydroxide powders are carried on the surface, or in the interior of, a sheet, woven fabric or unwoven fabric.
[9] A structure for preserving crustacean or sea foods, characterized in that the crustaceans or sea foods are placed on a woven or unwoven sheet carrying calcium oxide powders or calcium hydroxide powders, and the whole assembly is then filled up with calcium hydroxide-containing water.
[10] A structure for preserving crustacean or sea foods, characterized in that the crustaceans or sea foods are placed on a woven or unwoven sheet carrying calcium oxide powders or calcium hydroxide powders, and the whole assembly is covered up and solidified with calcium hydroxide-containing ice.

### Advantages of the Invention

According to the invention of the instant application, the laying-down of a sheet carrying calcium oxide powders and/or calcium hydroxide powders on the bottom of an enclosure with crustaceans or sea foods placed on the top surface thereof, followed by filling of water in the enclosure, is all that is needed to preserve the crustaceans or sea foods without decomposition over an extended period of time.

Specifically, the calcium oxide or hydroxide powders carried on and in the sheet dissolves in the water filled up in the enclosure 3 yielding a high pH calcium hydroxide solution that comes in contact with the peripheral surface and a portion of the interior of the crustaceans or sea foods with bactericidal effects.

If a number of crustaceans or the like are arranged and placed in a row on a first sheet and further covered up by a second sheet, then they are sandwiched between two such sheets so that they are protected from external forces and preserved safely with no risk of deformation.

### BRIEF EXPLANATION OF THE DRAWINGS

FIG. 1 is a plan view of live shrimps placed within the enclosure according to one example of the invention of the instant application.

FIG. 2 is a sectional view of FIG. 1.

FIG. 3 is a sectional view of another example.

The present invention will now be explained with reference to its examples.

The enclosure is first explained. For this, a water impermeable container is used in the form of a box container, a shallow-bottom pallet or the like.

Not by way of limitation, the enclosure is preferably sized to be deep enough to flatly arrange, for instance, 10 or more crustaceans in a row and stack them up in some rows.

For instance, the enclosure is preferably about 200 mm in width, about 30 mm in height, and about 200 mm in length. The enclosure may be formed of a metal, a boxboard or cardboard, a plastic material, a foamed resin, and so on.

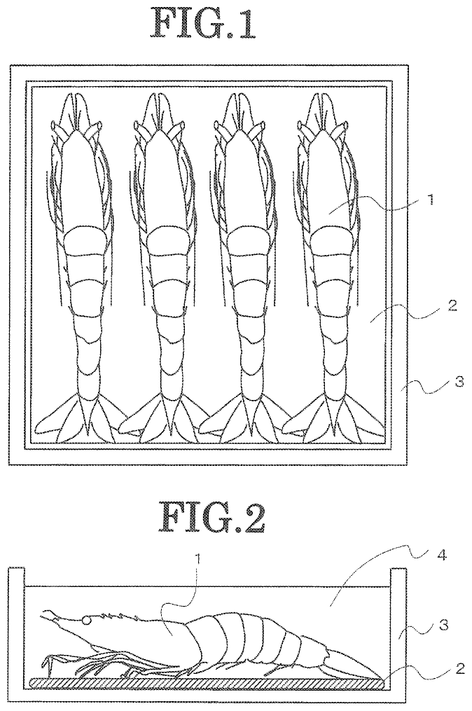

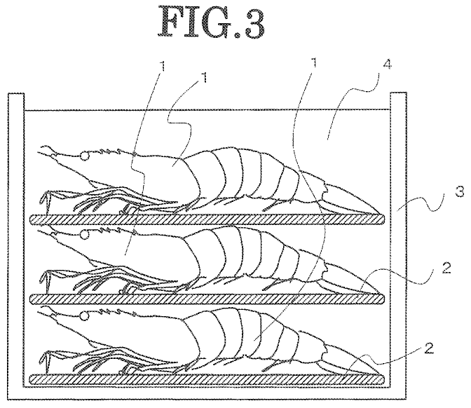

Referring to the accompanying drawings, FIG. 1 is a plan view of live shrimps placed within the enclosure; FIG. 2 is a sectional view of FIG. 1; and FIG. 3 is a sectional view of another example with reference numerals 1, 2, 3 and 4 pointing to live shrimps, a sheet, an enclosure and water, respectively.

Usually, the first sheet 2 carrying calcium oxide powders and/or calcium hydroxide powders is laid down on the bottom of the un-lidded enclosure 3 having a depth enough to accommodate live shrimps in vertically stacked 2 or 3 rows, and the live shrimps 1 cooled down to 3 to 8° C. and put into hibernation are arranged in a row on the top surface of the first sheet 2.

Thereupon, the second sheet 2 constructed as in the first sheet 1 is placed on the first sheet 1, and live shrimps 1 are then arranged and placed in a row on the top surface of the second sheet 2. The water 4 of about 3 to 8° C. is poured from above onto the thus assembled “sheet 2/live shrimps 1/sheet 2/live shrimps 1” multi-stacked structure wherein the live shrimps 1 are placed on the first sheet 2 and the live shrimps 1 are further placed on the second sheet 2 to fill the water up in the whole assembly.

If the assembly is allowed to stand in that state, the calcium oxide or calcium hydroxide carried in the sheet 2 elutes out yielding an alkaline solution having a pH value of as high as 12.5. This alkaline solution in turn comes in contact with the full periphery of the live shrimp with bactericidal effects.

It is here appreciated that with calcium hydroxide having a solubility of about 0.15%, there is an alkaline solution of pH 12.5 or more obtained; however, that solution is just only harmless to the ingestion by human beings whatsoever, but also provides calcium supplements as useful minerals.

For the sheet 2 it is preferable to use a woven or unwoven fabric wherein fibers capable of carrying calcium oxide or calcium hydroxide powders are entangled up.

Preferably, the powders are held on or between the fibers and carried by way of bonding or fusion. It is also preferable that the sheet 2 is so water-permeable that the carried calcium oxide or hydroxide powders are dissolvable in water and can flow out.

Such a woven or unwoven fabric is soft enough to do no damage to live shrimps and ensures that much more calcium oxide powders etc. can be carried.

For the water 4 filled up in the enclosure 3 use may be made of fresh water or a 0.12% calcium hydroxide solution (of pH 12.5).

In either case, the amount of the water 4 filled up in the enclosure 3 is preferably such that the sheet 2 and live shrimps 1 remain soaked or immersed in.

It is preferable that after filling the water up in the enclosure 3, freezing is applied by way of rapid cooling to create an ice body including the sheet 2 and sea foods/crustaceans for storage and transportation.

Calcium oxide or calcium hydroxide may be obtained by firing shells such as scallop shells and oyster shells or coral at a temperature of about 900° C. to about 1200° C. in air optionally with the addition of water.

Such fired calcium is composed mainly of calcium oxide (quicklime CaO) or calcium hydroxide (hydrated lime Ca(OH)₂); however, it may be formed of limestone by industrial firing.

Such fired calcium powders may preferably have a particle diameter of about 5 to 50 μm.

It is here understood that the calcium hydroxide solution to come into contact with sea foods, crustaceans or the like has preferably a concentration of about 0.15% and a pH value of about 12.5 because of having much higher bactericidal effects. Explanation of the Reference Numerals
1: Live Shrimps
2: Sheet
3: Enclosure
4: Water

1. A method for preserving crustaceans or sea foods, wherein a sheet carrying calcium oxide powders and/or calcium hydroxide powders is laid down on a bottom of an enclosure while the crustaceans or sea foods are placed on a top surface thereof, and water is then filled up within the enclosure.

2. A method for preserving crustaceans or sea foods according to claim 1, wherein a woven or unwoven sheet carrying calcium oxide powders and/or calcium hydroxide powders is laid down on the bottom of the enclosure while a number of crustaceans or sea foods are arranged and placed in the row on the top surface thereof, and the water is then filled up within the enclosure.

3. A method for preserving crustaceans or sea foods according to claim 1, wherein a woven or unwoven sheet carrying calcium oxide powders or calcium hydroxide powders is laid down on the bottom of the enclosure while a number of crustaceans or sea foods are arranged and placed in the row on the top surface thereof, and the water is then filled up within the enclosure and frozen.

4. A method for preserving crustaceans or sea foods according to claim 1, characterized in that wherein a woven or unwove sheet carrying calcium oxide powders and calcium hydroxide powders is laid down on the bottom of the enclosure while a number of crustaceans or sea foods are arranged and placed in the row on the top surface thereof, and the water is then filled up within the enclosure and frozen.

5. A method for preserving crustaceans or sea foods according to claim 1, wherein the water filled up within the enclosure is an aqueous solution of calcium hydroxide.

6. A method for preserving crustaceans or sea foods according to claim 1, wherein the crustacean is a live shrimp that has been cooled and put into hibernation.

7. A method for preserving crustaceans or sea foods according to claim 6, wherein the live shrimp has a head.

8. A sheet for use with the method for preserving crustaceans or sea foods according to claim 1, wherein calcium oxide powders or calcium hydroxide powders are carried on the surface, or in the interior of, a sheet, woven fabric or unwoven fabric.

9. A structure for preserving crustacean or sea foods, wherein the crustaceans or sea foods are placed on a woven or unwoven sheet carrying calcium oxide powders or calcium hydroxide powders, and the whole assembly is filled up with calcium hydroxide-containing water.

10. A structure for preserving crustacean or sea foods, wherein the crustaceans or sea foods are placed on a woven or unwoven sheet carrying calcium oxide powders or calcium hydroxide powders, and the whole assembly is covered up and solidified with calcium hydroxide-containing ice.
